(19) United States
(12) Patent Application Publication
(10) Pub. No.: US 2006/0200495 A1
(43) Pub. Date: Sep. 7, 2006

(54) SYSTEM AND METHOD FOR DISPLAYING AND EDITING INFORMATION SEARCH CONDITIONS

(75) Inventors: CHUNG-I LEE, Tu-Cheng (TW); CHIEN-FA YEH, Tu-Cheng (TW); Xiao-Di Fan, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/306,920

(22) Filed: Jan. 17, 2006

(30) Foreign Application Priority Data
Jan. 21, 2005 (TW) 94101772

(51) Int. Cl. G06F 17/00

(52) U.S. Cl. 707/104.1; 707/3

(57) ABSTRACT

A method for displaying and editing information search conditions includes steps: converting field searching components and operating components to graph components; receiving a search character string; defining minimum token units and constructing the search character string to a token sequence; identifying all minimum token units in the token sequence and converting corresponding graph components to a syntax tree; optimizing the syntax tree; and generating corresponding search codes. A related system is also disclosed.

### FIELD OF THE INVENTION

The present invention is generally related to a system and method for searching information.

### Description of Related Art

Searching information on the Internet has become common. The Internet makes it possible for users to access a large amount of information, and becomes the largest library and database of the world in a way. Computer systems that enable users to search information on the Internet are commercial available. These computer systems generally allow a user to enter search conditions by using a search keyword or a series of search keywords. Once such search keywords are entered, a list of information (such as web pages) corresponding to the search keywords is generated and displayed on a computer monitor. Such search keywords are keywords submitted to a search engine in order to search for particular information.

For example, when searching for a document by utilizing a search engine, the user designates one or more words or character trains as search keywords which are considered to be included in the document. According to the search keywords, the search engine searches the document including the search keywords in a search database, and generates and displays a document information list to the user as a result. In such a document information search apparatus, an index describing a list of important words of a document is used for the document, in order to search target documents existing on the network effectively. Such an index is also stored in the search database. When a request for searching for a document in the search database is issued from the user, the search engine searches the index in the search database preliminarily, and outputs a search result of the document information list.

A China patent application publication No. 1536512, entitled “Method for searching a telephone book rapidly” and published on Oct. 13, 2004, discloses a method for searching a telephone book. However, the patent application can only relate to a method for searching information and matching search conditions. The patent application fails to display and edit information search conditions.

Therefore, what is needed is a system and method for searching information, which can display and edit information search conditions.

### SUMMARY OF INVENTION

A system for displaying and editing information search conditions in accordance with a preferred embodiment runs in a document server, which connects with at least one client computer and a database. The database stores a syntax reference list, which typically includes definitions of field searching components, operating components and field value information. The system includes a component graphing module, a search character string receiving module, a character analyzing module, a syntax analyzing module, an optimizing module and a code generating module. The component graphing module is used for converting all field searching components and operating components to graph components. The search character string receiving module is used for receiving a search character string from the client computer. The character analyzing module is used for defining minimum token units of the search character string, and constructing the search character string to a token sequence. The syntax analyzing module is used for identifying all minimum units in the token sequence based on the syntax reference list, invoking corresponding graph components and converting the graph components into a syntax tree. The optimizing module is used for optimizing the syntax tree. The code generating module is used for generating search codes according to the optimized syntax tree.

A preferred method for displaying and editing information search conditions includes the step of: converting all field searching components and operating components to graph components; receiving a search character string; defining minimum token units of the search character string, and constructing the search character string to a token sequence; identifying all minimum units in the token sequence, invoking corresponding graph components and converting the graph components into a syntax tree; optimizing the syntax tree; and generating corresponding search codes according to the optimized syntax tree.

Another embodiment provides a method for displaying and editing information search conditions. The method includes the steps of: converting all field searching components and operating components to graph components; generating a syntax tree by dragging the graph components; assigning values to the graph components and generating search conditions; optimizing the syntax tree; and generating corresponding search codes according to the optimized syntax tree.

Other advantages and novel features of the present invention will be drawn from the following detailed description of a preferred embodiment and preferred method with the attached drawings, in which:

### BRIEF DESCRIPTION OF DRAWINGS

FIG. 1 is a schematic diagram of hardware configuration of a system for displaying and editing information search conditions in accordance with one embodiment;

FIG. 2 is a schematic diagram of software function modules of a document server of FIG. 1;

FIG. 3 is a schematic diagram of constructing a search character string to a token sequence;

FIG. 4 is a schematic diagram of a data structure tree of the search character sting of FIG. 3; and

FIG. 5 is a flowchart of a preferred method for displaying and editing information search conditions.

### DETAILED DESCRIPTION

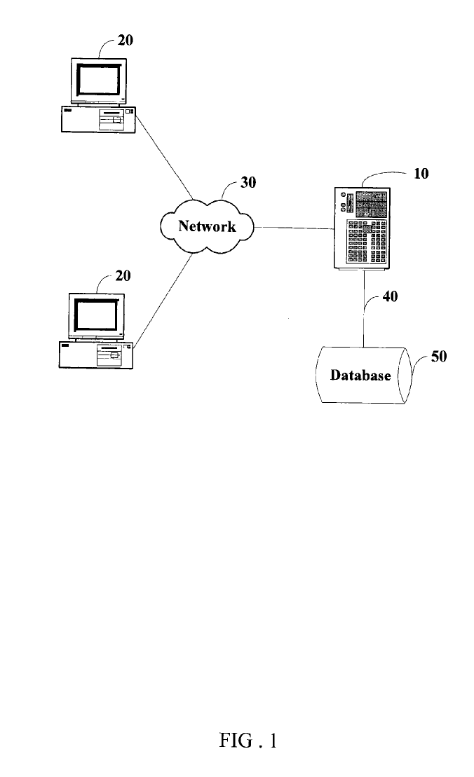

FIG. 1 is a schematic diagram of hardware configuration of a system for displaying and editing information search conditions (hereinafter, “the system”), in accordance with one preferred embodiment. In this preferred embodiment, such information search conditions are patent search conditions, and in alternative embodiments, such information search conditions can also be other information search conditions. The hardware configuration typically includes a document server 10, at least one client computer 20, a network 30, database connectivity 40 and a database 50. The system runs in the document server 10. The document server 10 is used for converting a search character string into a graphic tree and displaying the graphic tree. The document server 10 also stores a plurality of documents and information for searching according to the search character string. In the preferred embodiment, such documents are patent documents. The client computer 20 is connected with the document server 10 via the network 30, and provides a browser interface for a user to access the document server 10. The network 30 can be the Internet or a local area network.

The database 50 is connected with the document server 10 via the database connectivity 40, and stores a syntax definition file. The syntax definition file includes a syntax reference list, field searching tips and other related information. The syntax reference list typically includes definitions of operating components, field searching components and field value information. The operating components include “AND,” “OR,” and “NOT.” The field searching components may include “AN (Assignee Name),” “ACLM (Claim),” “ISD (Issue Date),” “PTO (Patent office),” “TTL (Title),” “PN (Patent Number),” “IN (Inventor Name)” and “APN (Application Number).” The field value information includes types of various field values, such as numeric data, character data and enumeration data (for example, patent type is a kind of enumeration data). For example, in a search character string “AN/(microsoft or ibm) and ACLM/BIOS and ISD/[2004.1.1-2004.12.31],” “AND” and “OR” are operating components; “AN,” “ACLM” and “ISD” are field searching components; the field values of “microsoft,” “ibm” and “BIOS” are character data, and the field value of “2004.1.1-2004.12.31” is numeric data.

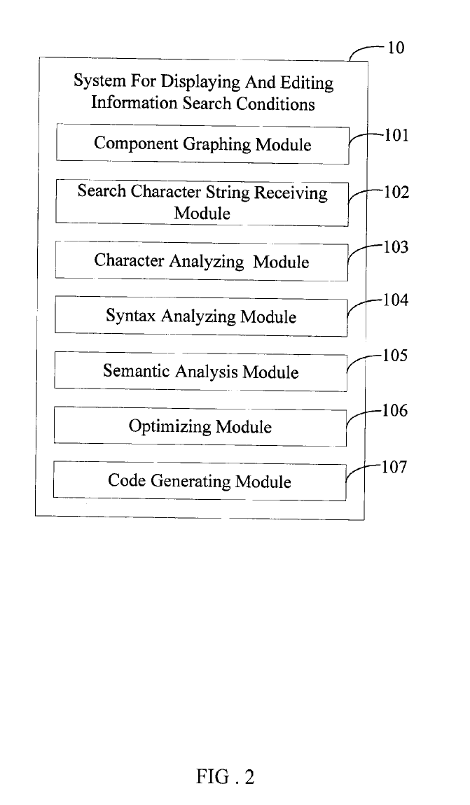

The FIG. 2 is a schematic diagram of software function modules of the system of FIG. 1. The system mainly includes a component graphing module 101, a search character string receiving module 102, a character analyzing module 103, a syntax analyzing module 104, a semantic analysis module 105, an optimizing module 106, and a code generating module 107.

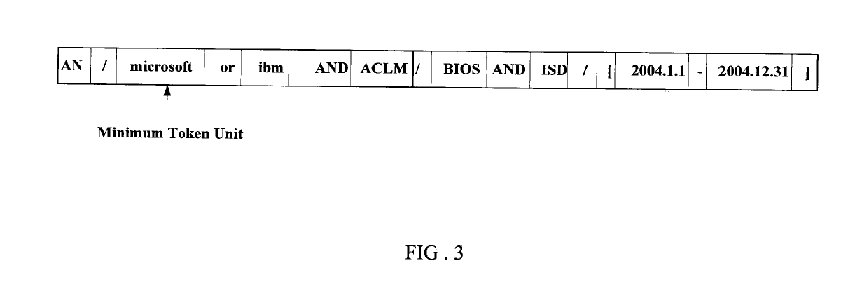

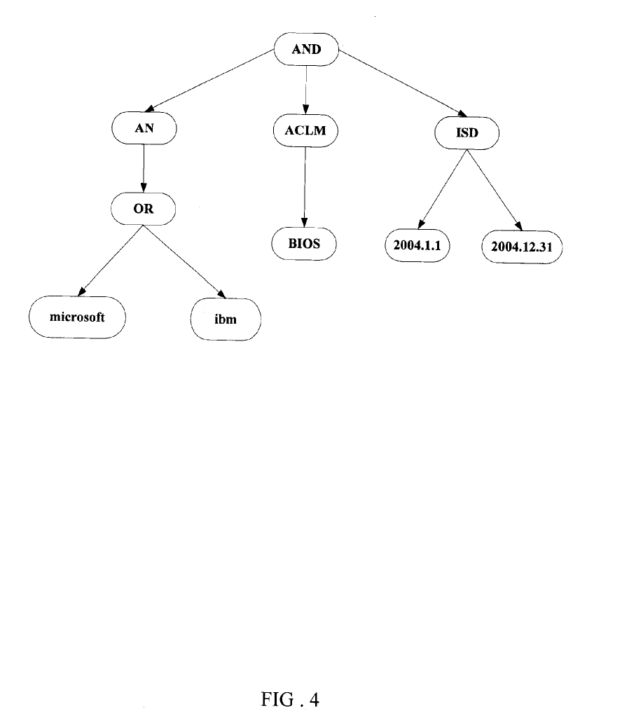

The component graphing module 101 is used for converting field searching components and operating components to graph components. The graph components can not only be dragged and assigned values in order to generate search conditions, but also be embedded in a query system. In the preferred embodiment, the query system is a patent query system. The search character string receiving module 102 is used for receiving a search character string through the client computer 20. The search character string is based on user's descriptions of search conditions and complies with particular patent searching syntax. For example, a user inputs “microsoft or ibm” in a column of “AN,” inputs “BIOS” in a column of “ACLM” and “2004.1.1-2004.12.31” in a column of “ISD,” the search character string receiving module 102 receives a corresponding search character string “AN/(microsoft or ibm) and ACLM/BIOS and ISD/[2004.1.1-2004.12.31].” The character analyzing module 103 is used for defining minimum token units of the search character string, and constructing the search character string to a token sequence. For the search character string “AN/(microsoft or ibm) and ACLM/BIOS and ISD/[2004.1.1-2004.12.31],” the character analyzing module 103 defines each component as a minimum token unit, thus obtaining seventeen minimum token units, which form a token sequence (shown in FIG. 3) stored in the database 50. The syntax analyzing module 104 is used for identifying all the minimum token units in the token sequence with the function of JJTree of javaCC. The syntax analyzing module 104 searches the syntax reference list in the database 50, invokes corresponding graph components, and constructs the graph components into a data structure tree (also named as a syntax tree and shown in FIG. 4). The syntax tree is displayed on the client computer 20 and stored in the database 50. The syntax tree may be described in Java or XML (extensible markup language). Typically, the graph components include graphic field searching components and graphic operating components. The syntax analyzing module 104 can be further used for editing the graph components in order to generate the syntax tree. Such editing may be dragging the graph components, assigning values to the graph components, increasing or deleting the graph components. The semantic analysis module 105 is used for searching the syntax reference list and corresponding field searching tips in the database 50, checking a type of each component, searching related field value information, and determining whether each of the types of field values of the components complies with the field value information. The optimizing module 106 is used for optimizing the syntax tree. For example, the optimizing module 106 optimizes the search character string “AN/‘microsoft’ or AN/‘ibm’” to “AN/(microsoft or ibm).” The code generating module 107 is used for generating search codes according to the optimized syntax tree, for searching corresponding documents or information stored in the document server 10.

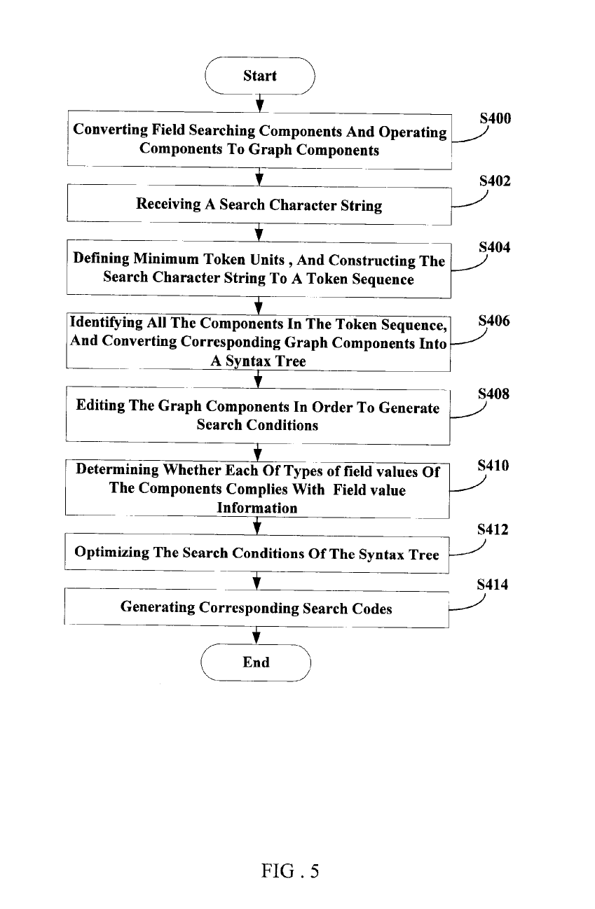

The FIG. 5 is a flowchart of a preferred method for displaying and editing information search conditions by utilizing the system of FIG. 1. In Step S400, the component graphing module 101 converts all field searching components and operating components to graph components. The graph components can be dragged and assigned values in order to generate search conditions. In Step S402, the search character string receiving module 102 receives a search character string from the client computer 20 according to user's descriptions of particular search conditions. In Step S404, the character analyzing module 103 defines minimum token units of the search character string, and constructs the search character string to a token sequence. In Step S406, the syntax analyzing module 104 identifies all the minimum token units in the token sequence based on a syntax reference list stored in the database 50, invokes corresponding graph components, and converts the graph components into a syntax tree. The syntax tree is displayed on the client computer 20. In Step S408, the syntax analyzing module 104 edits the graph components in order to generate other search conditions. Such editing may be dragging the graph components, assigning values to the graph components, increasing or deleting the graph components. In Step S410, the semantic analysis module 105 searches the syntax reference list and corresponding field searching tips in the database 50, and determines whether each of the types of field values of the components complies with the field value information. In Step S412, the optimizing module 106 combines certain relevant search conditions of the syntax tree, and optimizes the syntax tree. In Step S414, the code generating module 107 generates search codes according to the optimized syntax tree.

In an alternative embodiment, in Step S408, the syntax analyzing module 104 drags the graph components directly, and assigns values to the graph components, in order to generate a syntax tree.

Although the present invention has been specifically described on the basis of a preferred embodiment and a preferred method, the invention is not to be construed as being limited thereto. Various changes and modifications may be made to the embodiment and method without departing from the scope and spirit of the invention

What is claimed is:

1. A system for displaying and editing information search conditions, the system running in a document server, the document server being connected with at least one client computer and a database, the database storing a syntax reference list, the syntax reference list comprising definitions of field searching components and operating components; the system comprising:
a component graphing module for converting the field searching components and the operating components to graph components;
a search character string receiving module for receiving a search character string from the client computer;
a character analyzing module for defining minimum token units of the search character string, and constructing the search character string to a token sequence;
a syntax analyzing module for identifying all minimum token units in the token sequence, invoking corresponding graph components, and converting the graph components into a syntax tree;
an optimizing module for optimizing the syntax tree; and
a code generating module for generating search codes according to the optimized syntax tree.

2. The system according to claim 1, wherein the syntax analyzing module is further used for dragging the graph components directly and assigning values to the graph components in order to generate a syntax tree.

3. The system according to claim 1, wherein the code generating module uses JJTree for generating a graphic tree.

4. The system according to claim 1, further comprising a semantic analysis module for determining whether each of types of field values of the components complies with corresponding field value information.

5. A method for displaying and editing information search conditions, the method comprising the steps of:
converting all field searching components and operating components to graph components;
receiving a search character string;
defining minimum token units of the search character string, and constructing the search character string to a token sequence;
identifying all minimum token units in the token sequence based on a syntax reference list, invoking corresponding graph components and converting the graph components into a syntax tree;
optimizing the syntax tree; and
generating corresponding search codes according to the optimized syntax tree.

6. The method according to claim 5, wherein the graph components of the syntax tree can be dragged, assigned values, increased or deleted in order to generate other search conditions.

7. A method of displaying and editing information search conditions, the method comprising the steps of:
converting all field searching components and operating components to graph components;
generating a syntax tree by dragging the graph components;
assigning values to the graph components and generating search conditions;
optimizing the syntax tree; and
generating corresponding search codes according to the optimized syntax tree.
